(19) United States
(12) Patent Application Publication
(10) Pub. No.: US 2025/0111168 A1
(43) Pub. Date: Apr. 3, 2025

(54) METHODS, APPARATUSES AND COMPUTER PROGRAM PRODUCTS FOR NATURAL LANGUAGE GENERATION

(71) Applicant: Arria Data2Text Limited, Aberdeen (GB)

(72) Inventors: Neil Stuart Burnett, Banchory (GB); Kapila Anuruddha Ponnamperuma Arachchi, Banchory (GB); John William Alexander, Aberdeen (GB)

(21) Appl. No.: 18/793,398

(22) Filed: Aug. 2, 2024

Related U.S. Application Data
(60) Provisional application No. 63/586,812, filed on Sep. 29, 2023.

(51) Int. Cl. G06F 40/40

(52) U.S. Cl. CPC G06F 40/40

(57) ABSTRACT

Methods, apparatuses, and computer program products for a natural language generation system are described herein. An example method may include receiving, originating from a client computing device, an input data object. In some embodiments, the example method may include generating, based at least in part by applying a configuration model to the input data object, an intermediate natural language configuration data object. In some embodiments, the example method may include generating, based at least in part on applying a synthesis model to the intermediate natural language configuration data object, a natural language configuration data object. In some embodiments, the example method may include configuring the natural language configuration data object for use by a large language model in generating a natural language output representative of the input data object.

### CROSS-REFERENCE TO RELATED APPLICATIONS

This application claims the benefit of U.S. Provisional Patent Application No. 63/586,812, filed Sep. 29, 2023, the entire contents of which are incorporated by reference herein.

### TECHNOLOGICAL FIELD

Embodiments of the present disclosure relate generally to natural language generation and, more particularly, relate to methods, apparatuses, and computer program products for configuring a natural language configuration data object for use by a large language model in generating a natural language output representative of an input data object.

### BACKGROUND

Applicant has identified many technical challenges and difficulties associated with methods, apparatuses, and computer program products for configuring a natural language configuration data object for use by a large language model in generating a natural language output representative of an input data object. Through applied effort, ingenuity, and innovation, Applicant has solved problems related to methods, apparatuses, and computer program products for configuring a natural language configuration data object for use by a large language model in generating a natural language output representative of an input data object by developing solutions embodied in the present disclosure, which are described in detail below.

### BRIEF SUMMARY

Embodiments of the present disclosure provide methods, apparatus, systems, computing devices, and/or the like for configuring a natural language configuration data object for use by a large language model in generating a natural language output representative of an input data object.

In accordance with examples of the present disclosure, an apparatus is provided. In some embodiments, the apparatus comprises at least one processor and at least one non-transitory memory comprising program code. In some embodiments, the at least one non-transitory memory and the program code are configured to, with the at least one processor, cause the apparatus to receive, originating from a client computing device, an input data object. In some embodiments, the at least one non-transitory memory and the program code are configured to, with the at least one processor, cause the apparatus to generate, based at least in part by applying a configuration model to the input data object, an intermediate natural language configuration data object. In some embodiments, the at least one non-transitory memory and the program code are configured to, with the at least one processor, cause the apparatus to generate, based at least in part on applying a synthesis model to the intermediate natural language configuration data object, a natural language configuration data object. In some embodiments, the at least one non-transitory memory and the program code are configured to, with the at least one processor, cause the apparatus to configure the natural language configuration data object for use by a large language model in generating a natural language output representative of the input data object.

In some embodiments, the input data object is in one or more of a recurrent formal structure format or a natural language format.

In some embodiments, the natural language format is one or more of a natural language audio format or a natural language text format.

In some embodiments, generating the natural language configuration data object further includes the at least one non-transitory memory and the program code are configured to, with the at least one processor, cause the apparatus to apply the synthesis model to a supplementary intermediate natural language configuration data object.

In some embodiments, the supplementary intermediate natural language configuration data object is representative of one or more of an inclusion constraint, a size constraint, a model constraint, or a structure constraint.

In some embodiments, the configuration model is configured to generate, based at least in part on the input data object, an analytic operation instruction. In some embodiments, the analytic operation instruction defines at least one analytic operation type. In some embodiments, the configuration model is configured to determine the intermediate natural language configuration data object based at least in part on the analytic operation instruction.

In some embodiments, the at least one analytic operation type comprises one or more of a filtration operation, a grouping operation, a sorting operation, a trend operation, a correlation operation, an anomaly detection operation, a clustering operation, or a variance operation.

In accordance with examples of the present disclosure, a computer-implemented method is provided. In some embodiments, the computer-implemented method comprises receiving, originating from a client computing device, an input data object. In some embodiments, the computer-implemented method comprises generating, based at least in part by applying a configuration model to the input data object, an intermediate natural language configuration data object. In some embodiments, the computer-implemented method comprises generating, based at least in part on applying a synthesis model to the intermediate natural language configuration data object, a natural language configuration data object. In some embodiments, the computer-implemented method comprises configuring the natural language configuration data object for use by a large language model in generating a natural language output representative of the input data object.

In some embodiments, the input data object is in one or more of a recurrent formal structure format or a natural language format.

In some embodiments, the natural language format is one or more of a natural language audio format or a natural language text format.

In some embodiments, generating the natural language configuration data object further includes causing the apparatus to apply the synthesis model to a supplementary intermediate natural language configuration data object.

In some embodiments, the supplementary intermediate natural language configuration data object is representative of one or more of an inclusion constraint, a size constraint, a model constraint, or a structure constraint.

In some embodiments, the configuration model is configured to generate, based at least in part on the input data object, an analytic operation instruction. In some embodiments, the analytic operation instruction defines at least one analytic operation type. In some embodiments, the configuration model is configured to determine the intermediate natural language configuration data object based at least in part on the analytic operation instruction.

In some embodiments, the at least one analytic operation type comprises one or more of a filtration operation, a grouping operation, a sorting operation, a trend operation, a correlation operation, an anomaly detection operation, a clustering operation, or a variance operation.

In accordance with examples of the present disclosure, a computer program product is provided. In some embodiments, the computer program product comprises at least one non-transitory computer-readable storage medium having computer-readable program code portions stored therein. In some embodiments, the at least one non-transitory memory and the program code are configured to, with the at least one processor, cause the apparatus to receive, originating from a client computing device, an input data object. In some embodiments, the computer-readable program code portions comprising an executable portion configured to: generate, based at least in part by applying a configuration model to the input data object, an intermediate natural language configuration data object. In some embodiments, the computer-readable program code portions comprising an executable portion configured to: generate, based at least in part on applying a synthesis model to the intermediate natural language configuration data object, a natural language configuration data object. In some embodiments, the computer-readable program code portions comprising an executable portion configured to: configure the natural language configuration data object for use by a large language model in generating a natural language output representative of the input data object.

In some embodiments, the input data object is in one or more of a recurrent formal structure format or a natural language format.

In some embodiments, the natural language format is one or more of a natural language audio format or a natural language text format.

In some embodiments, generating the natural language configuration data object further includes the computer-readable program code portions comprising an executable portion configured to: apply the synthesis model to a supplementary intermediate natural language configuration data object.

In some embodiments, the supplementary intermediate natural language configuration data object is representative of one or more of an inclusion constraint, a size constraint, a model constraint, or a structure constraint.

In some embodiments, the configuration model is configured to generate, based at least in part on the input data object, an analytic operation instruction. In some embodiments, the analytic operation instruction defines at least one analytic operation type. In some embodiments, the configuration model is configured to determine the intermediate natural language configuration data object based at least in part on the analytic operation instruction.

In some embodiments, the at least one analytic operation type comprises one or more of a filtration operation, a grouping operation, a sorting operation, a trend operation, a correlation operation, an anomaly detection operation, a clustering operation, or a variance operation.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure. It will be appreciated that the scope of the disclosure encompasses many potential embodiments in addition to those here summarized, some of which will be further described below.

### BRIEF DESCRIPTION OF THE DRAWINGS

Having thus described some embodiments in general terms, references will now be made to the accompanying drawings, which are not necessarily drawn to scale, and wherein:

FIG. 1 is an example system architecture diagram illustrating a natural language generation environment in accordance with some embodiments of the present disclosure;

FIG. 2 is an example infrastructure diagram illustrating an example client device in accordance with some embodiments of the present disclosure;

FIG. 3 is an example infrastructure diagram illustrating an example natural language generation system in accordance with some embodiments of the present disclosure;

FIG. 4 illustrates an example dataflow diagram showing example data structures for configuring a natural language configuration data object for use by a large language model in accordance with some embodiments of the present disclosure;

FIG. 5 illustrates an example interface in accordance with some embodiments of the present disclosure;

FIG. 6 illustrates an example interface in accordance with some embodiments of the present disclosure; and

FIG. 7 illustrates an example method in accordance with some embodiments of the present disclosure.

### DETAILED DESCRIPTION OF VARIOUS EMBODIMENTS

Various embodiments of the present disclosure are described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as “comprises,” “includes,” and “having” should be understood to provide support for narrower terms such as “consisting of,” “consisting essentially of,” and “comprised substantially of.”

The phrases “in one embodiment,” “according to one embodiment,” “in some examples,” “for example,” and the like generally mean that the particular feature, structure, or characteristic following the phrase may be included in an embodiment of the present disclosure, and may be included in more than one embodiment of the present disclosure (importantly, such phrases do not necessarily refer to the same embodiment).

### OVERVIEW

Various embodiments of the present disclosure relate generally to natural language generation. More specifically, various embodiments of the present disclosure are related to configuring a natural language configuration data object for use by a large language model in generating a natural language output representative of an input data object.

Embodiments of the present disclosure present natural language generation techniques that improve configuration of a natural language configuration data object for use by a large language model in generating a natural language output representative of an input data object. To do so, the present disclosure provides a natural language generation system that leverages multiple different machine learning and/or rules-based models to configure a natural language configuration data object for use by a large language model in generating a natural language output representative of an input data object in an efficient, accurate, and scalable manner. The present disclosure provides a new natural language generation system and associated methods for implementing techniques for configurating a natural language configuration data object for use by a large language model.

Embodiments herein may be applied to an input data object as well as any other unstructured and/or structured input data to configure a natural language configuration data object for use by a large language model. To do so, the natural language generation system includes a configuration model configured to generate an intermediate natural language configuration data object based at least in part by applying the configuration model to the input data object. The natural language generation system may include a synthesis model configured to generate a natural language configuration data object based at least in part on an intermediate natural language configuration data object and/or a supplementary intermediate natural language configuration data object. The natural language generation system may include an output optimizer configured to configure a natural language configuration data object for use by a large language model in generating a natural language output representative of the input data object.

Example inventive and technological advantageous embodiments of the present disclosure include: a natural language generation system having (1) a configuration model configured to generate an intermediate natural language configuration data object based at least in part on an input data object; (2) a synthesis model configured to generate a natural language configuration data object based at least in part on an intermediate natural language configuration data object and/or a supplementary intermediate natural language configuration data object; (3) and/or an output optimizer configured to configure a natural language configuration data object for use by a large language model in generating a natural language output representative of the input data object. In this way, the present disclosure provides technical benefits that include (1) generating an optimized natural language configuration data object such that a large language model can be used to generate an optimized natural language output representative of an input data object and (2) enabling the generation of a natural language output representative of the input data object when the input data object is in a recurrent formal structure format.

### EXAMPLES OF CERTAIN TERMS

In some embodiments, the term “data object” refers to a data structure that represents one or more functionalities and/or characteristics associated with data and/or information.

In some embodiments, the term “input data object” refers to a data structure that represents one or more functionalities and/or characteristics associated with input data and/or input information. An input data object may be provided to a model to generate an output. In some embodiments, the model may be a rules-based and/or machine learning model. In some embodiments, an input data object may be in a recurrent formal structure format and/or a natural language format.

In some embodiments, the term “recurrent formal structure format” refers to a data format representing a data object. In some embodiments, a recurrent formal structure format may be a data format that includes a plurality of individual fields and defined relationships between the plurality of individual fields. For example, a data object in a recurrent formal structure format may represent data contained in a spreadsheet or database, presented in a tabulated log message, hierarchical structure, or other defined structure, encoded in a “knowledge representation” such as the resource description framework triples that make up the semantic web and/or the like. Additionally, or alternatively, in some embodiments, a data object in a recurrent formal structure format may represent data that includes symbolic content, such as alphanumeric and other non-numeric character sequences in any character encoding, used to represent arbitrary elements of information. Additionally, or alternatively, in some embodiments, a data object in a recurrent formal structure format may represent data in a JSON format. In some embodiments, an input data object may be in a recurrent formal structure format.

In some embodiments, the term “natural language format” refers to a data format representing a data object. In some embodiments, a natural language format may be a data format that includes words, phrases, sentences, paragraphs, messages, prompts, and/or the like, such as words, phrases, sentences, paragraphs, and/or the like in English, Spanish, and/or other languages. For example, a data object in a natural language format may represent data presented in words, phrases, sentences, paragraphs, and/or the like. In some embodiments, an input data object may be in a natural language format. In some embodiments, a natural language format may be one or more of a natural language audio format and/or a natural language text format.

In some embodiments, the term “natural language audio format” refers to a data format representing a data object. In some embodiments, a natural language audio format may be a data format that includes words, phrases, sentences, paragraphs, messages, prompts, and/or the like expressed in an audio manner, spoken manner, and/or the like. For example, a data object in a natural language audio format may represent data presented in words, phrases, sentences, paragraphs, and/or the like in an audio manner, spoken manner, and/or the like. In some embodiments, an input data object may be in a natural language audio format.

In some embodiments, the term “natural language text format” refers to a data format representing a data object. In some embodiments, a natural language text format may be a data format that includes words, phrases, sentences, paragraphs, messages, prompts, and/or the like expressed in text manner, written manner, and/or the like. For example, a data object in a natural language text format may represent data presented in words, phrases, sentences, paragraphs, and/or the like in a text manner, written manner, and/or the like. In some embodiments, an input data object may be in a natural language text format.

In some embodiments, the term “intermediate natural language configuration data object” refers to a data structure that represents one or more functionalities and/or characteristics associated with intermediate natural language configuration data and/or intermediate natural language configuration information. An intermediate natural language configuration data object may be provided to a model to generate an output. In some embodiments, the model may be a rules-based and/or machine learning model. In some embodiments, an intermediate natural language configuration data object may be in a natural language format.

In some embodiments, the term “configuration model” refers to a data entity that describes parameters, hyper-parameters, and/or defined operations of a rules-based and/or machine learning model. The configuration model may be configured to generate an intermediate natural language configuration data object based at least in part on an input data object. For example, an intermediate natural language configuration data object may be generated by applying the configuration model to an input data object. In this regard, for example, the configuration model may be configured to generate, based at least in part on an input data object, an analytic operation instruction and determine the intermediate natural language configuration data object based at least in part on the analytic operation instruction.

In some embodiments, the term “analytic operation instruction” refers to a data object that provides commands, directives, and/or specifications for conducting data analytic operations on another data object or a dataset. In some embodiments, an analytic operation instruction may define at least one analytic operation type.

In some embodiments, the term “analytic operation type” refers to a category of analytic operation. Examples of analytic operation types may include, but are not limited to, filtration operations, grouping operations, sorting operations, trend operations, correlation operations, anomaly detection operations, clustering operations, variance operations, any other analytic operation, and/or the like.

In some embodiments, the term “filtration operation” refers to a data object that provides filtration commands, filtration directives, and/or filtration specifications for conducting filtration analytics operations on another data object and/or the like. In some embodiments, a filtration operation may include generating one or more data objects by filtering data in a data object to identify relevant data in the data object (e.g., for the United Kingdom, Pepsi, Q1, etc.). For example, a filtration operation may include generating at least a portion of an intermediate natural language configuration data object by filtering an input data object.

In some embodiments, the term “grouping operation” refers to a data object that provides grouping commands, grouping directives, and/or grouping specifications for conducting grouping analytics operations on another data object and/or the like. In some embodiments, a grouping operation may include generating one or more data objects by grouping related data in a data object into one or more predefined groups (e.g., by country, product, quarter, etc.). For example, a grouping operation may include generating at least a portion of an intermediate natural language configuration data object by grouping an input data object.

In some embodiments, the term “sorting operation” refers to a data object that provides sorting commands, sorting directives, and/or sorting specifications for conducting sorting analytics operations on another data object and/or the like. In some embodiments, a sorting operation may include generating one or more data objects by sorting data in a data object (e.g., sorting into Q1, Q2, Q3, etc.). For example, a sorting operation may include generating at least a portion of an intermediate natural language configuration data object by sorting an input data object.

In some embodiments, the term “trend operation” refers to a data object that provides trend commands, trend directives, and/or trend specifications for conducting trend analytics operations on another data object and/or the like. In some embodiments, a trend operation may include generating one or more data objects by analyzing data in a data object to identify trends (e.g., inventory consumption has increased in Europe, sales decreased in Q1, etc.). For example, a trend operation may include generating at least a portion of an intermediate natural language configuration data object by analyzing an input data object to identify trends.

In some embodiments, the term “correlation operation” refers to a data object that provides correlation commands, correlation directives, and/or correlation specifications for conducting correlation analytics operations on another data object and/or the like. In some embodiments, a correlation operation may include generating one or more data objects by analyzing data in a data object to identify correlations (e.g., correlations between Q1 and Q2, correlations between the United Kingdom and Spain, etc.) For example, a correlation operation may include generating at least a portion of an intermediate natural language configuration data object by analyzing an input data object to identify correlations.

In some embodiments, the term “anomaly detection operation” refers to a data object that provides anomaly commands, anomaly directives, and/or anomaly specifications for conducting anomaly analytics operations on another data object and/or the like. In some embodiments, an anomaly operation may include generating one or more data objects by analyzing data in a data object to identify anomalies (e.g., a country is an outlier compared to other countries, a data point is an outlier compared to other related data points, etc.). For example, an anomaly detection operation may include generating at least a portion of an intermediate natural language configuration data object by analyzing an input data object to identify anomalies.

In some embodiments, the term “clustering operation” refers to a data object that provides clustering commands, clustering directives, and/or clustering specifications for conducting clustering analytics operations on another data object and/or the like. In some embodiments, a clustering operation may include generating one or more data objects by clustering related data in a data object into one or more clusters (e.g., data having a first characteristic into a first cluster, data having a second characteristic into a second cluster, etc.). For example, a clustering operation may include generating at least a portion of an intermediate natural language configuration data object by clustering an input data object.

In some embodiments, the term “variance operation” refers to a data object that provides variance commands, variance directives, and/or variance specifications for conducting variance analytics operations on another data object and/or the like. In some embodiments, a variance operation may include generating one or more data objects by variating data in a data object (e.g., by Q1 vs Q2 performance, drivers and offsets, etc.). For example, a variance operation may include generating at least a portion of an intermediate natural language configuration data object by variating an input data object.

In some embodiments, the term “supplementary intermediate natural language configuration data object” refers to a data structure that represents one or more functionalities and/or characteristics associated with supplementary intermediate natural language configuration data and/or supplementary intermediate natural language configuration information. A supplementary intermediate natural language configuration data object may be provided to a model to generate an output. In some embodiments, the model may be a rules-based and/or machine learning model. In some embodiments, a supplementary intermediate natural language configuration data object may be in a natural language format. In some embodiments, a supplementary intermediate natural language configuration data object may be distinct from an intermediate natural language configuration data object in that a supplementary intermediate natural language configuration data object may be associated with a first portion of a natural language configuration data object and an intermediate natural language configuration data object may be associated with a second portion of a natural language configuration data object. In some embodiments, a supplementary intermediate natural configuration data object may be representative of one or more of an inclusion constraint, a size constraint, a model constraint, and/or a structure constraint.

In some embodiments, the term “inclusion constraint” refers to a data structure that represents one or more functionalities and/or characteristics associated with inclusion constraint data and/or inclusion constraint information. An inclusion constraint may be provided to a model to generate an output. In some embodiments, the model may be a rules-based and/or machine learning model. For example, an inclusion constraint may be provided to a model such that the output generated by the model may include one or more particular words, characters, input data objects, and/or the like and/or may not include one or more particular words, characters, input data objects, and/or the like. In some embodiments, an inclusion constraint may be configured to increase accuracy associated with the output generated by the model. In some embodiments, an inclusion constraint may be in a natural language format.

In some embodiments, the term “size constraint” refers to a data structure that represents one or more functionalities and/or characteristics associated with size constraint data and/or size constraint information. A size constraint may be provided to a model to generate an output. In some embodiments, the model may be a rules-based and/or machine learning model. For example, a size constraint may be provided to a model such that the output generated by the model may be of a particular size (e.g., of a particular length). In some embodiments, a size constraint may be configured to reduce processing consumption and/or memory consumption associated with the model generating the output (e.g., enabling greater scalability and efficiency). In some embodiments, a size constraint may be in a natural language format.

In some embodiments, the term “model constraint” refers to a data structure that represents one or more functionalities and/or characteristics associated with model constraint data and/or model constraint information. A model constraint may be provided to a model to generate an output. In some embodiments, the model may be a rules-based and/or machine learning model. For example, a model constraint may be provided to a model such that the type, format, and/or parameters of the output generated by the model may be related to the type, format, and/or parameters of a model. In some embodiments, a model constraint may be configured to reduce processing consumption and/or memory consumption associated with the model generating the output (e.g., enabling greater scalability and efficiency). In some embodiments, a model constraint may be configured to increase accuracy associated with the output generated by the model. In some embodiments, a model constraint may be in a natural language format.

In some embodiments, the term “structure constraint” refers to a data structure that represents one or more functionalities and/or characteristics associated with structure data and/or structure information. A structure constraint may be provided to a model to generate an output. In some embodiments, the model may be a rules-based and/or machine learning model. For example, a structure constraint may be provided to a model such that the output generated by the model may be in a particular structure. In some embodiments, a structure constraint may be configured to increase accuracy associated with the output generated by the model. In some embodiments, a structure constraint may be in a natural language format.

In some embodiments, the term “natural language configuration data object” refers to a data structure that represents one or more functionalities and/or characteristics associated with natural language configuration data and/or natural language configuration information. A natural language configuration data object may be provided to a model to generate an output. In some embodiments, the model may be a rules-based and/or machine learning model. For example, the model may be a large language model. In some embodiments, an intermediate natural language configuration data object may be in a natural language format.

In some embodiments, the term “synthesis model” refers to a data entity that describes parameters, hyper-parameters, and/or defined operations of a rules-based and/or machine learning model. The synthesis model may be configured to generate a natural language configuration data object based at least in part on an intermediate natural language configuration data object and/or a supplementary intermediate natural language configuration data object. For example, a natural language configuration data object may be generated by applying the synthesis model to an intermediate natural language configuration data object and/or a supplementary intermediate natural language configuration data object.

In some embodiments, the term “large language model” refers to a data entity that describes parameters, hyper-parameters, and/or defined operations of a rules-based and/or machine learning model. A large language model may be configured to generate an output in natural language format based on an input in a natural language format. For example, a large language model may be configured to generate a natural language output representative of an input data object based at least in part on a natural language configuration data object.

In some embodiments, the term “natural language output” refers to a data structure that represents one or more functionalities and/or characteristics associated with natural language output data and/or natural language output data information. A natural language output may be received from a model configured to generate an output. In some embodiments, the model may be a rules-based and/or machine learning model. For example, the model may correspond to a large language model. In some embodiments, a natural langue output may be in a natural language format.

### EXAMPLE SYSTEM ARCHITECTURE

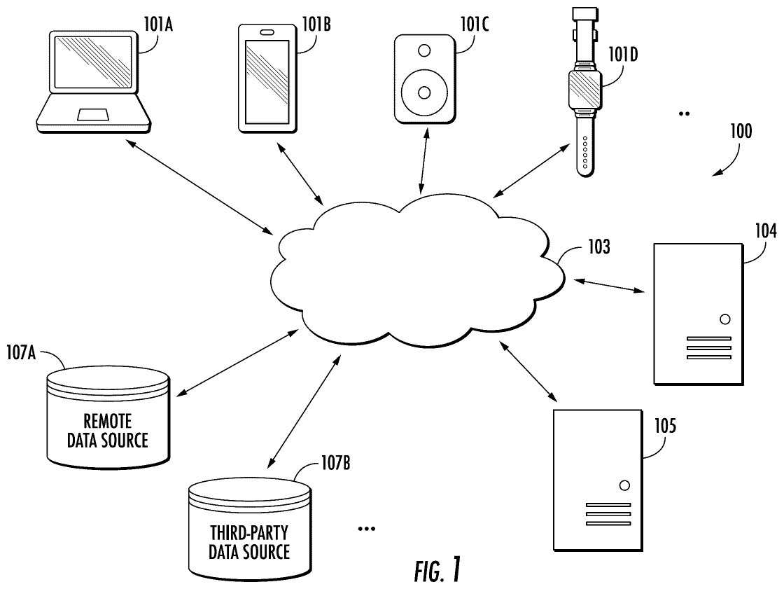

FIG. 1 is an example block diagram of example components of an example natural language generation environment 100. In the example shown in FIG. 1, the natural language generation environment 100 may comprise various components, such as, but not limited to, one (or more) natural language generation system 105, one (or more) large language model 10, one or more client devices 101A, 101B, 101C, 101D, . . . and one or more networks 103. In some embodiments, the natural language generation environment 100 may comprise one or more data storage devices (such as data storage devices 107A, 107B, . . . ).

Each of the example components of the example natural language generation environment 100 may be in electronic communication with, for example, one another over the same or different networks 103. In some embodiments, such as illustrated in FIG. 1, the natural language generation system 105 and the large language model 10 may be separate components of the example natural language generation environment 100. In some embodiments, the natural language generation system 105 and the large language model 10 may be a single component of the example natural language generation environment. For example, the natural language generation system 105 may include the large language model 10. As another example, the large language model 10 may include the natural language generation system 105.

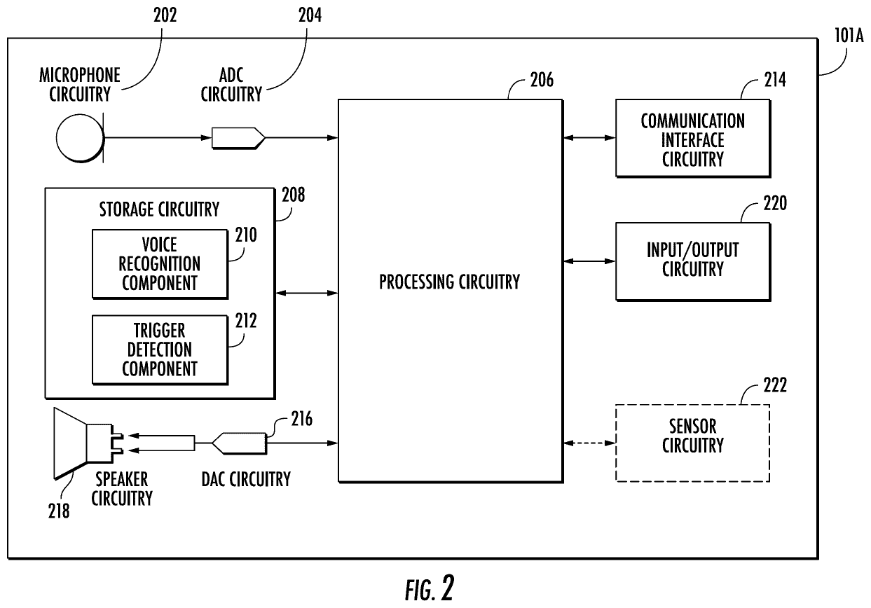

For example, users may communicate, converse and/or interact with the natural language generation system 105 and/or the large language model 10 via one or more networks (such as one or more networks 103) using one or more client devices (such as client devices 101A, 101B, 101C, 101D, . . . . The client devices 101A, 101B, 101C, 101D, . . . may be a computing device. For example, the client devices 101A, 101B, 101C, 101D may include desktop computers, laptop computers, tablet computers, smartphones, wearables, smart speakers, smart televisions, smart home appliances (including, but not limited to, smart refrigerators, smart washer, smart dryer), voice controllers, devices with integrated intelligent virtual assistant (IVA) or intelligent personal assistant (IPA), and/or the like. An example infrastructure diagram of an example client device is illustrated in FIG. 2 and described in detail herein.

In some embodiments, a user may communicate, converse and/or interact with the natural language generation system 105 and/or the large language model 10 by providing voice, sound, and/or other types of audio data. For example, the client device 101A may comprise a microphone circuitry that may detect and/or capture audio data from the environment surrounding the client device 101A. The client device 101A may analyze audio data, convert applicable audio data to input data objects, and transmit the input data objects to the natural language generation system 105 and/or the large language model 10.

In some embodiments, the client device 101A may analyze audio data to determine whether the use has triggered, requested, and/or prompted communication, conversation and/or interaction with the natural language generation system 105 and/or the large language model 10. For example, by analyzing the audio data, the client device 101A may determine that a user has spoken a trigger word or phrase that indicates a request to communicate, converse and/or interact with the natural language generation system 105 and/or the large language model 10. Subsequently, the client device 101A may convert the audio data into input data objects and may transmit the input data objects to the natural language generation system 105 and/or the large language model 10.

In some embodiments, a user may communicate, converse and/or interact with the natural language generation system 105 and/or the large language model 10 by inputting text and/or other types of non-audio data to a client device. For example, the client device 101A may comprise an input/output circuitry (for example, a keyboard, a mouse, etc.) that may allow a user to provide non-audio data to the client device 101A (for example, by typing or selecting a request to communicate, converse and/or interact with the natural language generation system 105 and/or the large language model 10). Based on the non-audio data, the client device 101A may generate input data objects, and transmit the input data objects to the natural language generation system 105 and/or the large language model 10.

In some embodiments, communication, conversation and/or interaction between a user (via a client device) and the natural language generation system 105 and/or large language model 10 may be triggered, promoted, and/or directed based on one or more triggering events. For example, the client device may comprise one or more sensor circuitries, such as, but not limited to, one or more touch sensors, one or more accelerometers, one or more gyroscopes, one or more pressure sensors, one or more capacitive sensors and/or the like. As an example, the client device 101B may be in the form of a mobile device that comprises a physical button and a pressure sensor electronically coupled to the physical button. Based on detecting that a user has pressed the physical button for a time duration longer than a predetermined time period, the client device 101B may trigger a microphone circuitry to detect and/or capture audio data, and/or trigger an input/output circuitry to detect and/or capture non-audio data. Subsequently, the client device 101B may convert the audio data and/or non-audio data into input data objects and may transmit the input data objects to the natural language generation system 105 and/or large language model 10.

While the description above provides some examples of initiating, triggering, and conducting communication, conversation, and/or interaction between a user and the natural language generation system 105 and/or large language model 10, it is noted that the scope of the present disclosure is not limited to the description above. In some examples, communication, conversation, and/or interaction may be initiated, triggered, and/or conducted additionally or alternatively through other means or mechanisms.

Referring back to FIG. 1, the one or more networks 103 may include, but are not limited to, any one or a combination of different types of suitable communications networks. Such networks may include, but not limited to, a wired or wireless local area network (LAN), personal area network (PAN), metropolitan area network (MAN), wide area network (WAN), or the like, as well as any hardware, software and/or firmware required to implement it (such as, e.g., network routers, etc.).

For example, one or more networks 103 may include an 802.11, 802.16, 802.20, and/or WiMax network. The one or more networks 103 may include medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof. The one or more networks 103 may include a public network (such as the Internet), a private network (such as an intranet), or combinations thereof, and may utilize a variety of networking protocols including, but not limited to, TCP/IP based networking protocols. As an example, the networking protocol may be customized to suit the needs of the natural language generation system 105 and/or large language model 10. In some embodiments, the protocol may be a custom protocol of JSON objects sent via a WebSocket channel. In some embodiments, the protocol may be JSON over RPC, JSON over REST/HTTP, and the like.

In some embodiments, data and/or information (such as, but not limited to, input data objects) may be sent to the natural language generation system 105 and/or the large language model 10 via, for example, the one or more networks 103 directly by one or more client devices 101A, 101B, 101C, 101D. . . . Additionally, or alternatively, these data and/or information may be sent to the natural language generation system 105 and/or large language model 10 by a client device and via one or more intermediaries (such as another client device).

In various embodiments of the present disclosure, the natural language generation system 105 and/or large language model 10 may comprise one or more hardware components (such as circuitries) and software components (such as software systems/modules) that may be configured to generate one or more output responses based on input data objects received by the natural language generation system 105 and/or the large language model 10 (for example, input data objects that are generated by and transmitted from one or more client devices 101A, 101B, . . . ), additional details of which are described herein.

In the example shown in FIG. 1, the example natural language generation environment 100 may comprise one or more data storage devices (such as data storage devices 107A, 107B, . . . ) in electronic communications with the natural language generation system 105 and/or the large language model 10. For example, the data storage device 107A may provide remote data sources (e.g., remote reference data, remote user data, and/or the like). The data storage device 107B may provide third-party data sources (for example, data stored in a database that is external to the natural language generation system 105 and/or the large language model 10). Additionally, or alternatively, the example natural language generation environment 100 may comprise more (or less) data storage devices as compared to those shown in the example of FIG. 1.

In some embodiments, the natural language generation system 105 and/or the large language model 10 may transmit one or more output responses to a client device (such as one of the one or more client devices 101A, 101B, 101C, 101D . . . ) through the one or more networks 103. Additionally, or alternatively, one or more output responses may be transmitted to a client device through the one or more networks 103 and via one or more intermediaries (such as another client device).

In some embodiments, subsequent to receiving the output response(s), a client device may convert the output response(s) into audio data and may output the audio data through a speaker circuitry. Additionally, or alternatively, client device may convert the output response(s) into non-audio data (such as, but not limited to, written texts, graphics, and/or the like), and may render the non-audio data for display through a display circuitry.

As such, in various example embodiments of the present disclosure, communication, conversation, and/or interaction between a user and the natural language generation system 105 and/or the large language model 10 may be initiated, triggered, and/or conducted based at least on the user providing audio data (for example, speaking into a client device) and/or non-audio data (for example, typing into the client device). The user may receive an output response from the natural language generation system 105 and/or the large language model 10 (that may be converted into audio data and/or non-audio data as described above), and may continue the communication, conversation, and/or interaction by providing additional audio data and/or non-audio data (and receiving additional output responses from the natural language generation system 105 and/or the large language model 10).

While the description above provides an example architecture of an example natural language generation environment, it is noted that the scope of the present disclosure is not limited to the description above. In some examples, an example natural language generation environment may comprise one or more additional and/or alternative elements. For example, while FIG. 1 illustrates certain devices as separate, standalone entities, the various embodiments of the present disclosure are not limited to this particular architecture.

### EXAMPLE CLIENT DEVICE

FIG. 2 provides an illustrative schematic representative of a client device 101A that can be used in conjunction with embodiments of the present disclosure.

In the example shown in FIG. 2, the client device 101A may include one or more components, such as, but not limited to, a processing circuitry 206, a storage circuitry 208, a communication interface circuitry 214.

In some embodiments, the client device 101A may optionally include a microphone circuitry 202 and an analog-to-digital converter (ADC) circuitry 204. In some embodiments, the client device 101A may optionally include a speaker circuitry 218 and a digital-to-analog converter (DAC) circuitry 216. In some embodiments, the client device 101A may optionally include an input/output circuitry 220. In some embodiments, the client device 101A may optionally include a sensor circuitry 222.

In embodiments where the client device 101A comprises the microphone circuitry 202, the microphone circuitry 202 may comprise one or more sensors, transducers, and/or signal detecting apparatuses that may be configured to detect and/or capture acoustic signal(s) (for example, acoustic waveform(s)) that represent audio data. Examples of the microphone circuitry 202 may include, but not limited to, a piezoelectric microphone, a micro-electrical-mechanical system (MEMS) microphone, a large diaphragm condenser microphone, a small diaphragm condenser microphone, a carbon microphone, a liquid microphone, an electret condenser microphone, a dynamic microphone, and/or the like. For example, the microphone circuitry 202 may detect acoustic signal(s) from the environment surrounding the client device 101A, which may include, for example, user's voice or sound made by a user.

In some embodiments, the microphone circuitry 202 may be electronically coupled to the ADC circuitry 204. The ADC circuitry 204 may convert acoustic signal(s) to digital signal(s). Examples of the ADC circuitry 204 may include, but not limited to, flash ADC, successive-approximation register ADC, and/or the like. For example, the ADC circuitry 204 may convert acoustic waveforms into audio data that can be processed by the processing circuitry 206.

While the description above provides an example of the microphone circuitry 202 being electronically coupled to the ADC circuitry 204, it is noted that the scope of the present disclosure is not limited to the description above. In some embodiments, the microphone circuitry 202 may comprise an integrated ADC circuitry within the microphone circuitry 202, such that a separate ADC circuitry is not required.

In the example shown in FIG. 2, the ADC circuitry 204 (or the microphone circuitry 202 having an integrated ADC circuitry) is electronically coupled to the processing circuitry 206 and may transmit audio data to the processing circuitry 206.

The processing circuitry 206 may be embodied in a number of different ways and may, for example, include one or more same or different processing devices configured to perform independently or jointly. For example, the processing circuitry 206 may be embodied as one or more complex programmable logic devices (CPLDs), microprocessors, multi-core processors, coprocessing entities, application-specific instruction-set processors (ASIPs), and/or controllers. Further, the processing circuitry 206 may be embodied as one or more other processing devices or circuitry. The term circuitry may refer to an entirely hardware embodiment or a combination of hardware and computer program products. Thus, the processing circuitry 206 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing circuitry 206 may be configured for a particular use or configured to execute instructions stored in one or more storage circuitries (such as, but not limited to, one or more memories, one or more volatile or non-volatile computer-readable storage mediums and/or one or more data repositories that are accessible to the processing circuitry 206). As such, whether configured by hardware or computer program products, or by a combination thereof, the processing circuitry 206 may be capable of performing steps or operations according to embodiments of the present disclosure when configured accordingly. In some embodiments, the processing circuitry 206 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

Referring to FIG. 2, the processing circuitry 206 may be electronically coupled to the storage circuitry 208, such that the processing circuitry 206 may be configured to execute instructions stored in the storage circuitry 208.

The storage circuitry 208 may be embodied in a number of different ways and may, for example, include one or more same or different data storage devices configured to perform independently or jointly. For example, the storage circuitry 208 may comprise one or more volatile computer-readable storage mediums. In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like.

Additionally, or alternatively, the storage circuitry 208 may comprise one or more non-volatile computer-readable storage mediums. In some embodiments, a non-volatile computer-readable storage medium may include a floppy disk, flexible disk, hard disk, solid-state storage (SSS) (e.g., a solid-state drive (SSD), solid-state card (SSC), solid-state module (SSM), enterprise flash drive, magnetic tape, or any other non-transitory magnetic medium, and/or the like. Additionally, or alternatively, a non-volatile computer-readable storage medium may include compact disc read only memory (CD-ROM), compact disc-rewritable (CD-RW), digital versatile disc (DVD), Blu-ray disc (BD), any other non-transitory optical medium, and/or the like. Additionally, or alternatively, a non-volatile computer-readable storage medium may include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Additionally, or alternatively, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

It will be appreciated that, where embodiments are described to use a computer-readable storage medium, other types of computer-readable storage media may be substituted for or used in addition to the computer-readable storage media described above.

In accordance with various embodiments of the present disclosure, one or more computer program products may be installed and/or stored in a storage circuitry. Example computer program products may include, but not limited to, software components such as one or more software components, applications, software objects, methods, data structures, and/or the like.

In the present disclosure, a software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution. Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

In the example shown in FIG. 2, a voice recognition component 210 and/or a trigger detection component 212 may be stored in the storage circuitry 208. In some embodiments, the voice recognition component 210 may comprise one or more software components that are configured to determine whether audio data (for example, received from the microphone circuitry 202 and/or the ADC circuitry 204) comprises data/information that represents a human voice, and/or the identity of the voice (i.e., whom the voice is originated from). For example, the voice recognition component 210 may comprise algorithms, such as, but not limited to, classification-based algorithms (e.g., algorithms based on Mel frequency cepstral coefficients (MFCC) and/or linear prediction cepstral coefficients (LPCC)). Additionally, or alternatively, the voice recognition component 210 may implement one or more machine learning models, such as, but not limited to, artificial neural network (ANN), vector quantization (VQ), and/or dynamic time warping (DTW).

If the voice recognition component 210 determines that the audio data comprises data/information that represents a human voice, and/or the identity of the voice corresponds to an authorized user of the client device 101A, the voice recognition component 210 may transmit the audio data to the trigger detection component 212. The trigger detection component 212 may comprise one or more software components that are configured to determine whether the audio data comprises data/information that represents a trigger word, a trigger phrase, a trigger sentence, and/or a trigger audio sequence that indicates a user's request to communicate, converse and/or interact with a natural language generation system and/or a large language model (for example, the natural language generation system 105 and/or the large language model 10 shown above in connection with FIG. 1). For example, the voice recognition component 210 may comprise machine learning algorithms, such as, but not limited to, deep neural network (DNN). As an example, the DNN may calculate a plurality of trigger scores based on the audio data and determine whether these trigger scores satisfy one or more threshold values and/or conditions. Based on one or more of the plurality of trigger scores satisfying the one or more threshold values and/or conditions, the trigger detection component 212 may determine that the audio data comprises data/information that represents a trigger word, a trigger phrase, a trigger sentence, and/or a trigger audio sequence.

Based on determining that the audio data comprises data/information indicating a user's request to communicate, converse and/or interact with a natural language generation system and/or large language model, the processing circuitry 206, in communication with the storage circuitry 208, may convert the audio data into input data objects, and cause the communication interface circuitry 214 to transmit the input data objects to a natural language generation system and/or large language model (for example, the natural language generation system 105 and/or the large language model 10). For example, the processing circuitry 206 may execute one or more algorithms and/or models that may convert and/or translate audio data into input data objects in the form of text (for example, a speech-to-text algorithm that converts an audio recording to a natural language expression that corresponds to text of the audio recording). For example, the processing circuitry 206 may execute an algorithm based on the Hidden Markov Models (HMM) s. In such an example, the HMMs may model time-varying spectral vector sequences based on the audio data. Additionally, or alternatively, the processing circuitry 206 may generate text using other algorithms and/or models, such as, but not limited to, machine learning models (e.g., ANN, VQ, DTW, and/or the like).

Based on determining that the audio data comprises data/information not indicating a user's request to communicate, converse and/or interact with a natural language generation system and/or large language model, the processing circuitry 206, in communication with the storage circuitry 208, may discard or delete the audio data.

While the description above provides some example software modules stored in the storage circuitry 208, it is noted that the scope of the present disclosure is not limited to the description above. In some examples, an example storage circuitry 208 may comprise one or more additional and/or alternative software modules.

Further, while the description above provides an example of a user triggering, requesting, and/or conducting communication, conversation and/or interaction with an example natural language generation system and/or large language model through audio, it is noted that the scope of the present disclosure is not limited to this example only. Additionally, or alternatively, a user may trigger, request, and/or conduct communication, conversation and/or interaction with the natural language generation system 105 through non-audio means.

For example, in some embodiments of the present disclosure, the client device 101A may include an input/output circuitry 220. Examples of input/output circuitry 220 may include, but are not limited to, a display circuitry (including, but are not limited to, a cathode ray tube (CRT) display, a liquid crystal display LCD (LCD), a Light-emitting diode (LED) display, an organic light-emitting diode (OLED) display, a quantum light-emitting diode (QLED) display, a mini-LED display, and/or the like), a keyboard circuitry, a mouse circuitry, and/or the like. For example, the input/output circuitry 220 may be configured to provide an application, browser, user interface, dashboard, webpage, and/or the like that are executed on and/or accessible via the client device 101A to cause display of information/data and for user interaction therewith via one or more user input interfaces. The input/output circuitry 220 may comprise any of a number of devices allowing the client device 101A to receive data, such as a keypad (hard or soft), a keyboard, a touch display, motion interfaces, scanners, readers, or other input device. In embodiments including a keypad, the keypad can include (or cause display of) the conventional numeric (0-9) and related keys (#, *), and other keys used for operating the client device 101A and may include a full set of alphabetic keys or set of keys that may be activated to provide a full set of alphanumeric keys.

For example, the user may provide user input data in the form of non-audio data to the client device via a keyboard and/or a mouse. The processing circuitry 206 may analyze the non-audio data and determine that the non-audio data comprise the user's request to communicate, converse and/or interact with a natural language generation system and/or large language model (for example, the natural language generation system 105 and/or large language model 10). Accordingly, the processing circuitry 206 may convert the non-audio data to input data objects and may transmit the input data objects to a natural language generation system and/or large language model (for example, the natural language generation system 105 and/or large language model 10).

Additionally, or alternatively, the client device 101A may comprise a sensor circuitry 222. Examples of the sensor circuitry 222 may include, but are not limited to, a touch sensor, an accelerometer, a gyroscope, a pressure sensor, a capacitive sensor, a proximity sensor, an ambient light sensor, and/or the like. As described above, the sensor circuitry 222 may be configured to detect one or more triggering events (for example, a user has pressed the physical button for a time duration longer than a predetermined time period) as indicating a user's request to communicate, converse and/or interact with a natural language generation system and/or large language model (for example, the natural language generation system 105 and/or large language model 10). Subsequent to detecting the one or more triggering events, the processing circuitry 206 may convert audio data (generated by the microphone circuitry 202 and/or the ADC circuitry 204) and/or non-audio data (generated by the input/output circuitry 220) into input data objects and transmit the input data objects to the communication interface circuitry 214.

In some embodiments, the communication interface circuitry 214 may communicate with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. For example, the communication interface circuitry 214 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The natural language generation system 105 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram

Protocol (UDP), Datagram Congestion Control Protocol (DCCP), Stream Control Transmission Protocol (SCTP), HyperText Markup Language (HTML), and/or the like.

For example, the communication interface circuitry 214 may transmit input data objects to a natural language generation system and/or large language model (for example, the natural language generation system 105 and/or the large language model 10), and may receive data, content, and/or information (such as output responses) from the natural language generation system and/or large language model (for example, the natural language generation system 105 and/or the large language model 10). Subsequently, the communication interface circuitry 214 may communicate such data, content, and/or information with the processing circuitry 206.

In embodiments where the client device 101A comprises the speaker circuitry 218 (and the DAC circuitry 216), the processing circuitry 206 may execute one or more algorithms and/or models that may convert and/or translate output responses into audio data (e.g., a text-to-speech algorithm that converts texts into audio). For example, the processing circuitry 206 may execute one or more speech synthesis modules stored in the storage circuitry 208 to convert the output response into audio data and may transmit the audio data to the speaker circuitry 218 (or the DAC circuitry 216).

In some embodiments, the DAC circuitry 216 may convert audio data to acoustic signal(s) (for example, acoustic waveform(s)). In some embodiments, the DAC circuitry 216 may be electronically coupled to the speaker circuitry 218. In some embodiments, the speaker circuitry 218 may comprise an integrated DAC circuitry within the speaker circuitry 218, such that a separate DAC circuitry is not required.

In some embodiments, the speaker circuitry 218 may be configured to output acoustic signals (for example, acoustic waveforms). Examples of the speaker circuitry 218 may include, but not limited to, moving-iron speakers, piezoelectric speakers, electrostatic loudspeakers, and/or the like.

While the description above provides an example of presenting output responses generated by an example natural language generation system and/or large language model through audio means, it is noted that the scope of the present disclosure is not limited to this example only. Additionally, or alternatively, output responses generated by an example natural language generation system and/or large language model may be presented to a user through non-audio means.

For example, as described above, an example input/output circuitry 220 may comprise a display circuitry. In some embodiments, the processing circuitry 206 may cause the output responses rendered for display through the display circuitry.

As such, in various example embodiments of the present disclosure, a user may communicate, converse and/or interact with an example natural language generation system and/or large language model via the client device 101A through audio means (for example, through the microphone circuitry 202 and/or the speaker circuitry 218) and/or non-audio means (for example, through the input/output circuitry 220). The client device 101A may generate and transmit input data objects to a natural language generation system and/or large language model, and the natural language generation system and/or large language model may generate and transmit output responses to the client device 101A.

### EXAMPLE NATURAL LANGUAGE GENERATION SYSTEM

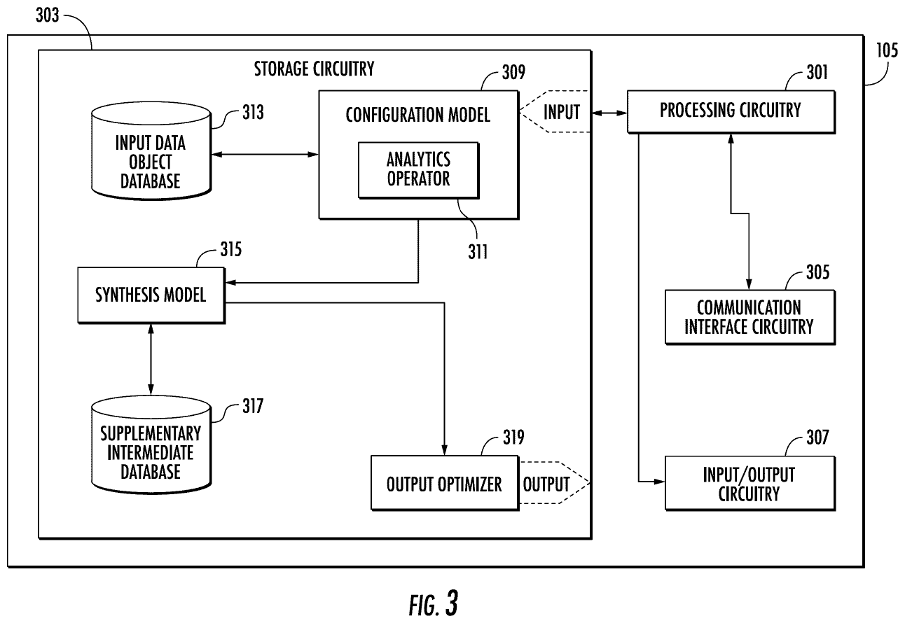

FIG. 3 provides an illustrative schematic representative of an example natural language generation system 105 that can be used in conjunction with embodiments of the present disclosure.

In the example shown in FIG. 3, the natural language generation system 105 may include one or more components, such as, but are not limited to, one or more of a processing circuitry 301, a storage circuitry 303, and a communication interface circuitry 305. In some embodiments, the natural language generation system 105 may optionally include an input/output circuitry 307.

In some embodiments, the processing circuitry 301 may be embodied in a number of different ways and may, for example, include one or more same or different processing devices configured to perform independently or jointly. In some embodiments, the processing circuitry 301 may be similar to the processing circuitry 206 described above in connection with FIG. 2.

In some embodiments, the communication interface circuitry 305 may communicate with various computing entities, such as by communicating data, content, information. In some embodiments, the communication interface circuitry 305 may be similar to the communication interface circuitry 214 described above in connection with FIG. 2.

In some embodiments, the input/output circuitry 307 may include a display circuitry, a keyboard circuitry, a mouse circuitry, and/or the like. In some embodiments, the input/output circuitry 307 may be similar to the input/output circuitry 220 described above in connection with FIG. 2.

In some embodiments, the storage circuitry 303 may be embodied in a number of different ways and may, for example, include one or more same or different data storage devices configured to perform independently or jointly, similar to those described above in connection with FIG. 2. In accordance with various embodiments of the present disclosure, one or more computer program products may be installed and/or stored in the storage circuitry 303.

In the example shown in FIG. 3, the storage circuitry 303 may store computer program products that include one or more of a configuration model 309, an input data object database 313, a synthesis model 315, a supplementary intermediate database 317, and/or an output optimizer 319.

In some embodiments, the storage circuitry 303 may be configured to receive an input data object. In some embodiments, the storage circuitry 303 may be configured to receive an input data object that has originated from a client device (e.g., client device 101A). In some embodiments, the storage circuitry 303 may be configured to store an input data object in the input data object database 313. In some embodiments, an input data object may be in one or more of a recurrent formal structure format and/or a natural language format. In some embodiments, an input data object may be in one or more of a natural language audio format and/or a natural language text format.

In some embodiments, subsequent to receiving an input data object (e.g., by retrieving the input data object from the input data object database 313), the processing circuitry 301 may execute the configuration model 309 to generate an intermediate natural language configuration data object based at least in part on the input data object. In this regard, for example, an analytics operator 311 of the configuration model 309 may be configured to generate, based at least in part on the input data object, an analytic operation instruction and determine the intermediate natural language configuration data object based at least in part on the analytic operation instruction.

In some embodiments, the analytic operation instruction may define at least one analytic operation type. In some embodiments, the at least one analytic operation type may include one or more filtration operations, grouping operations, sorting operations, trend operations, correlation operations, anomaly detection operations, clustering operations, variance operations, any other analytic operations, and/or the like. In this regard, for example, the analytics operator 311 may be configured to generate, based at least in part on the input data object, an intermediate natural language configuration data object by performing one or more filtration operations, grouping operations, sorting operations, trend operations, correlation operations, anomaly detection operations, clustering operations, and/or variance operations.

In some embodiments, the storage circuitry 303 may be configured to receive a supplementary intermediate natural language configuration data object. In some embodiments, the storage circuitry 303 may be configured to receive a supplementary intermediate natural language configuration data object that has originated from a client device (e.g., client device 101A). In some embodiments, the storage circuitry 303 may be configured to store the supplementary intermediate natural language configuration data object in the supplementary intermediate database 317. In some embodiments, a supplementary intermediate natural configuration data object may be representative of one or more of an inclusion constraint, a size constraint, a model constraint, and/or a structure constraint.

In some embodiments, subsequent to generating an intermediate natural language configuration data object and/or receiving a supplementary intermediate natural language configuration data object (e.g., by retrieving the supplementary intermediate natural language configuration data object from the supplementary intermediate database 317), the processing circuitry 301 may execute the synthesis model 315 to generate a natural language configuration data object. In this regard, for example, executing the synthesis model 315 to generate a natural language configuration data object may include applying the synthesis model 315 to an intermediate natural language configuration data object and/or a supplementary intermediate natural language configuration data object.

In some embodiments, subsequent to generating a natural language configuration data object, the processing circuitry 302 may execute the output optimizer 319 to configure the natural language configuration data object. For example, the output optimizer 319 may be configured to configure the natural language configuration data object for use by a large language model in generating a natural language output that is representative of the input data object.

In some embodiments, for example, configuring the natural language configuration data object for use by a large language model in generating a natural language output that is representative of the input data object may include transmitting the natural language configuration data object to large language model 10. As another example, in some embodiments, configuring the natural language configuration data object for use by a large language model in generating a natural language output that is representative of the input data object may include processing the natural language configuration data object using the large language model 10 (e.g., when the natural language generation system 105 and the large language model 10 are a single component). As another example, in some embodiments, configuring the natural language configuration data object for use by a large language model in generating a natural language output that is representative of the input data object may include causing the natural language configuration data object to be processed by the large language model 10 (e.g., by instructing the large language model 10 to process the natural language configuration data object).

While the description above provides examples of generating a natural language response regarding sales data, it is noted that scope of the present disclosure is not limited to this example only. In some embodiments, various examples of the present disclosure may provide one or more natural language response in other topic(s), such that various embodiments of the present disclosure are not topic specific.

### EXAMPLE DATAFLOW

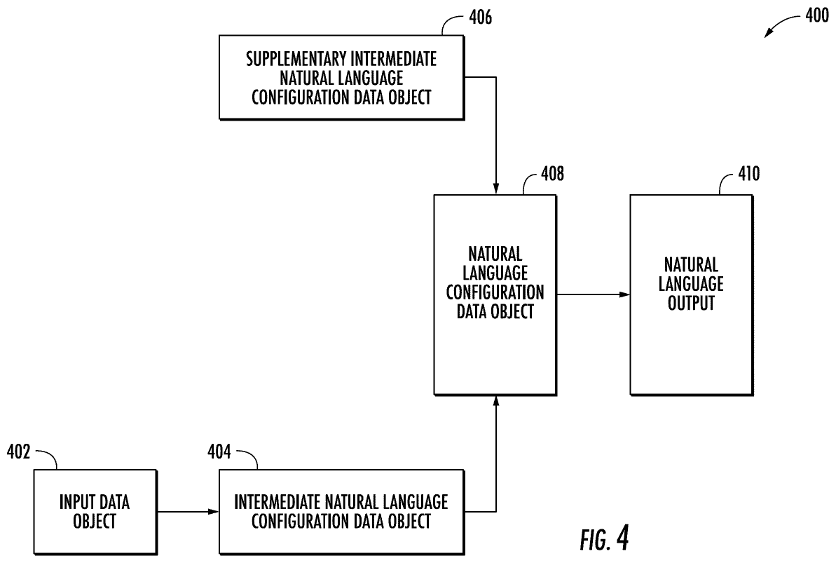

FIG. 4 is a dataflow diagram showing example data structures for facilitating the configuration of a natural language configuration data object for use by a large language model. The dataflow diagram 400 depicts a set of data structures and algorithms for facilitating configuration of a natural language configuration data object for use by a large language model.

In some embodiments, the input data object 402 is a data structure that represents one or more functionalities and/or characteristics associated with input data and/or input information. An input data object may be provided to a model to generate an output. In some embodiments, the model may be a rules-based and/or machine learning model. In some embodiments, an input data object may be in a recurrent formal structure format and/or a natural language format.

In some embodiments, the configuration model 309 may be configured to generate an intermediate natural language configuration data object 404 based at least in part on the input data object 402. In some embodiments, the intermediate natural language configuration data object may be a data structure that represents one or more functionalities and/or characteristics associated with intermediate natural language configuration data and/or intermediate natural language configuration information. An intermediate natural language configuration data object may be provided to a model to generate an output. In some embodiments, the model may be a rules-based and/or machine learning model. In some embodiments, an intermediate natural language configuration data object may be in a natural language format.

In some embodiments, the supplementary intermediate natural language configuration data object 406 may be a data structure that represents one or more functionalities and/or characteristics associated with supplementary intermediate natural language configuration data and/or supplementary intermediate natural language configuration information. A supplementary intermediate natural language configuration data object may be provided to a model to generate an output. In some embodiments, the model may be a rules-based and/or machine learning model. In some embodiments, a supplementary intermediate natural language configuration data object may be in a natural language format. In some embodiments, a supplementary intermediate natural language configuration data object may be distinct from an intermediate natural language configuration data object in that a supplementary intermediate natural language configuration data object may be associated with a first portion of a natural language configuration data object and an intermediate natural language configuration data object may be associated with a second portion of a natural language configuration data object. In some embodiments, a supplementary intermediate natural configuration data object may be representative of one or more of an inclusion constraint, a size constraint, a model constraint, and/or a structure constraint.

In some embodiments, the synthesis model 315 may be configured to generate a natural language configuration data object 408 based at least in part on the intermediate natural language configuration data object 404 and/or the supplementary intermediate natural language configuration data object 406.

In some embodiments, the natural language configuration data object 408 may be a data structure that represents one or more functionalities and/or characteristics associated with natural language configuration data and/or natural language configuration information. A natural language configuration data object may be provided to a model to generate an output. In some embodiments, the model may be a rules-based and/or machine learning model. For example, the model may be a large language model. In some embodiments, an intermediate natural language configuration data object may be in a natural language format.

In some embodiments, the output optimizer 319 may be configured to configurate the natural language configuration data object 408 for use by a large language model (e.g., large language model 10) in generating a natural language output 410 representative of the input data object 402. In some embodiments, the natural language output 410 may be a data structure that represents one or more functionalities and/or characteristics associated with natural language output data and/or natural language output data information. A natural language output may be received from a model configured to generate an output. In some embodiments, the model may be a rules-based and/or machine learning model. For example, the model may correspond to a large language model. In some embodiments, a natural langue output may be in a natural language format.

### EXAMPLE INTERFACES

Having described example systems, apparatuses, and data structures in accordance with the disclosure, example interfaces and associated interface comments in accordance with the disclosure will now be described. In some embodiments, the example interfaces embody user interfaces renderable to a particular display to be outputted to a user associated with a particular computing device, system, and/or the like. In some embodiments, the interfaces are renderable by the natural language generation system 105, for example where the interfaces are outputted for rendering to a particular display of the natural language generation system 105. Additionally, or alternatively, in some embodiments, the natural language generation system 105 transmits particular data to a client device associated with the natural language generation system 105 to cause rendering of the interface to a display of the client device.

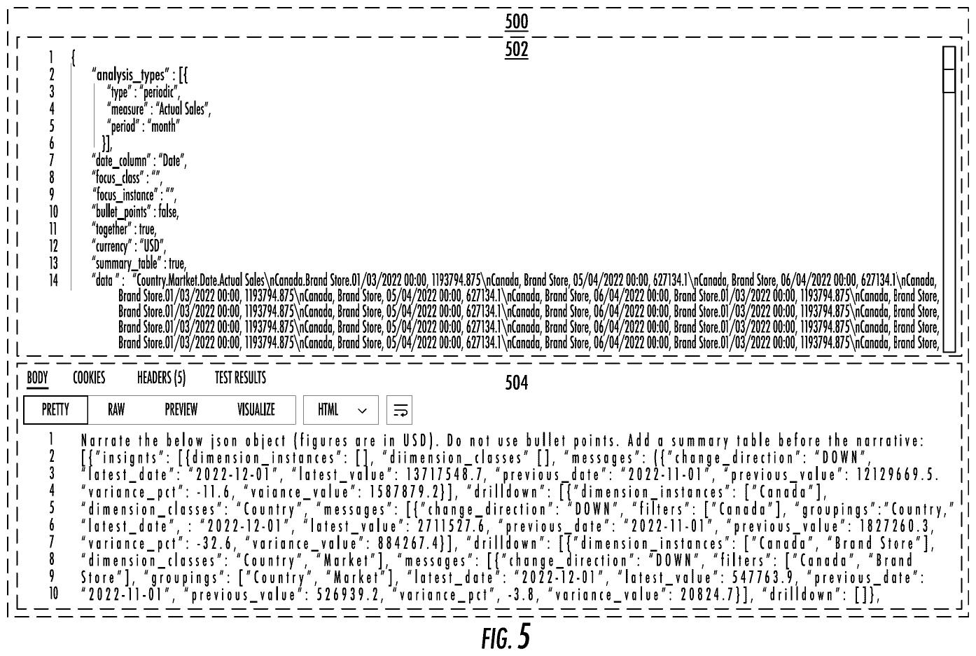

FIG. 5 illustrates and example interface 500. The interface 500 may include one or more components. Specifically, the interface 500 may include an input data object component 502. The input data object component 502 may be configured to display input data objects. For example, the input data object component 502 may be configured to display input data objects such as country, market, month, etc. The interface 500 may include a natural language configuration data object component 504. The natural language configuration data object component 504 may be configured to display natural language configuration data objects. For example, the natural language configuration data object component 504 may be configured to display natural language configuration data objects such as “narrate the below JSON object,” “latest data,” etc.

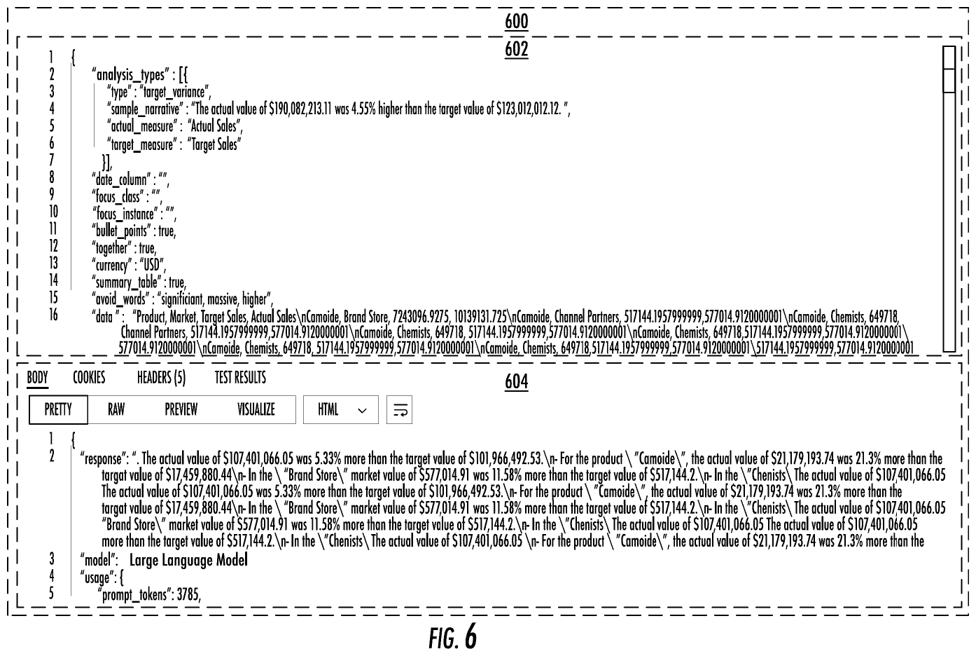

FIG. 6 illustrates and example interface 600. The interface 600 may include one or more components. Specifically, the interface 600 may include an input data object component 602. The input data object component 602 may be configured to display input data objects. For example, the input data object component 602 may be configured to display input data objects such as target sales, actual sales, etc. The interface 600 may include a natural language output component 604. The natural language output component 604 may be configured to display a natural language output. For example, the natural language output component 604 may be configured to display a natural language output such as “the actual value of $107, 401,066.05 was 5.33% more than . . . ”.

### EXAMPLE METHODS

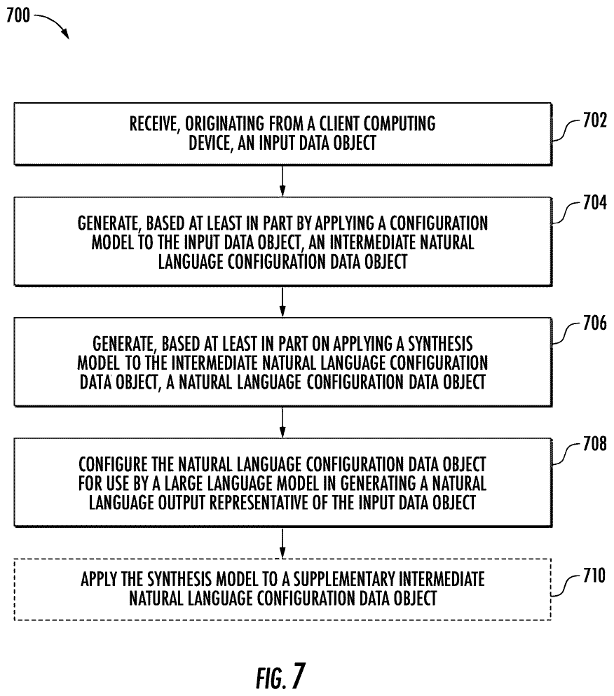

Various methods described herein, including, for example, an example method shown in FIG. 7 provide a natural language generation system. For example, the example method shown in FIG. 7 may be executed by a processing circuitry discussed above in connection with FIG. 3.

It is noted that each block of the flowchart, and combinations of blocks in the flowchart, may be implemented by various means such as hardware, firmware, circuitry and/or other devices associated with execution of software including one or more computer program instructions. For example, one or more of the procedures described in FIG. 7 may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As described above, various example embodiments of the present disclosure are related to providing a natural language generation system that may be able to configure a natural language configuration data object for use by a large language model in generating a natural language output representative of an input data object.

FIG. 7 illustrates and example method 700 associated with a natural language generation system in accordance with example embodiments of the present disclosure.

In some embodiments, the method 700 includes, at step/operation 702, receiving, originating from a client computing device, an input data object. In some embodiments, an input data object may be a data structure that represents one or more functionalities and/or characteristics associated with input data and/or input information. An input data object may be provided to a model to generate an output. In some embodiments, the model may be a rules-based and/or machine learning model. In some embodiments, an input data object may be in a recurrent formal structure format and/or a natural language format.

In some embodiments, a recurrent formal structure format may be a data format representing a data object. In some embodiments, a recurrent formal structure format may be a data format that includes a plurality of individual fields and defined relationships between the plurality of individual fields. For example, a data object in a recurrent formal structure format may represent data contained in a spreadsheet or database, presented in a tabulated log message, hierarchical structure, or other defined structure, encoded in a “knowledge representation” such as the resource description framework triples that make up the semantic web and/or the like. Additionally, or alternatively, in some embodiments, a data object in a recurrent formal structure format may represent data that includes symbolic content, such as alphanumeric and other non-numeric character sequences in any character encoding, used to represent arbitrary elements of information. Additionally, or alternatively, in some embodiments, a data object in a recurrent formal structure format may represent data in a JSON format. In some embodiments, an input data object may be in a recurrent formal structure format.

In some embodiments, a natural language format may be a data format representing a data object. In some embodiments, a natural language format may be a data format that includes words, phrases, sentences, paragraphs, messages, prompts, and/or the like, such as words, phrases, sentences, paragraphs, and/or the like in English, Spanish, and/or other languages. For example, a data object in a natural language format may represent data presented in words, phrases, sentences, paragraphs, and/or the like. In some embodiments, an input data object may be in a natural language format. In some embodiments, a natural language format may be one or more of a natural language audio format and/or a natural language text format.

In some embodiments, the method 700 includes, at step/operation 704, generating, based at least in part by applying a configuration model to the input data object, an intermediate natural language configuration data object. In some embodiments, an intermediate natural language configuration data object may be a data structure that represents one or more functionalities and/or characteristics associated with intermediate natural language configuration data and/or intermediate natural language configuration information. An intermediate natural language configuration data object may be provided to a model to generate an output. In some embodiments, the model may be a rules-based and/or machine learning model. In some embodiments, an intermediate natural language configuration data object may be in a natural language format.

In some embodiments, the configuration model may be a data entity that describes parameters, hyper-parameters, and/or defined operations of a rules-based and/or machine learning model. The configuration model may be configured to generate an intermediate natural language configuration data object based at least in part on an input data object. For example, an intermediate natural language configuration data object may be generated by applying the configuration model to an input data object. In this regard, for example, the configuration model may be configured to generate, based at least in part on an input data object, an analytic operation instruction and determine the intermediate natural language configuration data object based at least in part on the analytic operation instruction.

In some embodiments, an analytic operation instruction may be a data object that provides commands, directives, and/or specifications for conducting data analytic operations on another data object or a dataset. In some embodiments, an analytic operation instruction may define at least one analytic operation type. In some embodiments, an analytic operation type may be a category of analytic operation. Examples of analytic operation types may include, but are not limited to, filtration operations, grouping operations, sorting operations, trend operations, correlation operations, anomaly detection operations, clustering operations, variance operations, any other analytic operations, and/or the like.

In some embodiments, a filtration operation may be a data object that provides filtration commands, filtration directives, and/or filtration specifications for conducting filtration analytics operations on another data object and/or the like. In some embodiments, a filtration operation may include generating one or more data objects by filtering data in a data object to identify relevant data in the data object (e.g., for the United Kingdom, Pepsi, Q1, etc.). For example, a filtration operation may include generating at least a portion of an intermediate natural language configuration data object by filtering an input data object.

In some embodiments, a grouping operation may be a data object that provides grouping commands, grouping directives, and/or grouping specifications for conducting grouping analytics operations on another data object and/or the like. In some embodiments, a grouping operation may include generating one or more data objects by grouping related data in a data object into one or more predefined groups (e.g., by country, product, quarter, etc.). For example, a grouping operation may include generating at least a portion of an intermediate natural language configuration data object by grouping an input data object.

In some embodiments, a sorting operation may be a data object that provides sorting commands, sorting directives, and/or sorting specifications for conducting sorting analytics operations on another data object and/or the like. In some embodiments, a sorting operation may include generating one or more data objects by sorting data in a data object (e.g., sorting into Q1,Q2, Q3, etc.). For example, a sorting operation may include generating at least a portion of an intermediate natural language configuration data object by sorting an input data object.

In some embodiments, a trend operation may be a data object that provides trend commands, trend directives, and/or trend specifications for conducting trend analytics operations on another data object and/or the like. In some embodiments, a trend operation may include generating one or more data objects by analyzing data in a data object to identify trends (e.g., inventory consumption has increased in Europe, sales decreased in Q1, etc.). For example, a trend operation may include generating at least a portion of an intermediate natural language configuration data object by analyzing an input data object to identify trends.

In some embodiments, a correlation operation may be a data object that provides correlation commands, correlation directives, and/or correlation specifications for conducting correlation analytics operations on another data object and/or the like. In some embodiments, a correlation operation may include generating one or more data objects by analyzing data in a data object to identify correlations (e.g., correlations between Q1 and Q2, correlations between the United Kingdom and Spain, etc.) For example, a correlation operation may include generating at least a portion of an intermediate natural language configuration data object by analyzing an input data object to identify correlations.

In some embodiments, an anomaly detection operation may be a data object that provides anomaly commands, anomaly directives, and/or anomaly specifications for conducting anomaly analytics operations on another data object and/or the like. In some embodiments, an anomaly operation may include generating one or more data objects by analyzing data in a data object to identify anomalies (e.g., a country is an outlier compared to other countries, a data point is an outlier compared to other related data points, etc.). For example, an anomaly detection operation may include generating at least a portion of an intermediate natural language configuration data object by analyzing an input data object to identify anomalies.

In some embodiments, a clustering operation may be a data object that provides clustering commands, clustering directives, and/or clustering specifications for conducting clustering analytics operations on another data object and/or the like. In some embodiments, a clustering operation may include generating one or more data objects by clustering related data in a data object into one or more clusters (e.g., data having a first characteristic into a first cluster, data having a second characteristic into a second cluster, etc.). For example, a clustering operation may include generating at least a portion of an intermediate natural language configuration data object by clustering an input data object.

In some embodiments, a variance operation may be a data object that provides variance commands, variance directives, and/or variance specifications for conducting variance analytics operations on another data object and/or the like. In some embodiments, a variance operation may include generating one or more data objects by variating data in a data object (e.g., by Q1 vs Q2performance, drivers and offsets, etc.). For example, a variance operation may include generating at least a portion of an intermediate natural language configuration data object by variating an input data object.

In some embodiments, the method 700 includes, at step/operation 706, generating, based at least in part on applying a synthesis model to the intermediate natural language configuration data object, a natural language configuration data object. In some embodiments, a natural language configuration data object may be to a data structure that represents one or more functionalities and/or characteristics associated with natural language configuration data and/or natural language configuration information. A natural language configuration data object may be provided to a model to generate an output. In some embodiments, the model may be a rules-based and/or machine learning model. For example, the model may be a large language model. In some embodiments, an intermediate natural language configuration data object may be in a natural language format.

In some embodiments, a synthesis model may be to a data entity that describes parameters, hyper-parameters, and/or defined operations of a rules-based and/or machine learning model. The synthesis model may be configured to generate a natural language configuration data object based at least in part on an intermediate natural language configuration data object and/or a supplementary intermediate natural language configuration data object. For example, a natural language configuration data object may be generated by applying the synthesis model to an intermediate natural language configuration data object and/or a supplementary intermediate natural language configuration data object.

In some embodiments, the method 700 includes, at step/operation 708, configuring the natural language configuration data object for use by a large language model in generating a natural language output representative of the input data object. In some embodiments, a large language model may be a data entity that describes parameters, hyper-parameters, and/or defined operations of a rules-based and/or machine learning model. A large language model may be configured to generate an output in natural language format based on an input in a natural language format. For example, a large language model may be configured to generate a natural language output representative of an input data object based at least in part on a natural language configuration data object.

In some embodiments, a natural language output may be a data structure that represents one or more functionalities and/or characteristics associated with natural language output data and/or natural language output data information. A natural language output may be received from a model configured to generate an output. In some embodiments, the model may be a rules-based and/or machine learning model. For example, the model may correspond to a large language model. In some embodiments, a natural langue output may be in a natural language format.

In some embodiments, the method 700 optionally includes, at step/operation 710, applying the synthesis model to a supplementary intermediate natural language configuration data object. In some embodiments, a supplementary intermediate natural language configuration data object may be a data structure that represents one or more functionalities and/or characteristics associated with supplementary intermediate natural language configuration data and/or supplementary intermediate natural language configuration information. A supplementary intermediate natural language configuration data object may be provided to a model to generate an output. In some embodiments, the model may be a rules-based and/or machine learning model. In some embodiments, a supplementary intermediate natural language configuration data object may be in a natural language format. In some embodiments, a supplementary intermediate natural language configuration data object may be distinct from an intermediate natural language configuration data object in that a supplementary intermediate natural language configuration data object may be associated with a first portion of a natural language configuration data object and an intermediate natural language configuration data object may be associated with a second portion of a natural language configuration data object. In some embodiments, a supplementary intermediate natural configuration data object may be representative of one or more of an inclusion constraint, a size constraint, a model constraint, and/or a structure constraint.

In some embodiments, an inclusion constraint may be a data structure that represents one or more functionalities and/or characteristics associated with inclusion constraint data and/or inclusion constraint information. An inclusion constraint may be provided to a model to generate an output. In some embodiments, the model may be a rules-based and/or machine learning model. For example, an inclusion constraint may be provided to a model such that the output generated by the model may include one or more particular words, characters, input data objects, and/or the like and/or may not include one or more particular words, characters, input data objects, and/or the like. In some embodiments, an inclusion constraint may be configured to increase accuracy associated with the output generated by the model. In some embodiments, an inclusion constraint may be in a natural language format.

In some embodiments, a size constraint may be a data structure that represents one or more functionalities and/or characteristics associated with size constraint data and/or size constraint information. A size constraint may be provided to a model to generate an output. In some embodiments, the model may be a rules-based and/or machine learning model. For example, a size constraint may be provided to a model such that the output generated by the model may be of a particular size (e.g., of a particular length). In some embodiments, a size constraint may be configured to reduce processing consumption and/or memory consumption associated with the model generating the output (e.g., enabling greater scalability and efficiency). In some embodiments, a size constraint may be in a natural language format.

In some embodiments, a model constraint may be a data structure that represents one or more functionalities and/or characteristics associated with model constraint data and/or model constraint information. A model constraint may be provided to a model to generate an output. In some embodiments, the model may be a rules-based and/or machine learning model. For example, a model constraint may be provided to a model such that the type, format, and/or parameters of the output generated by the model may be related to the type, format, and/or parameters of a model. In some embodiments, a model constraint may be configured to reduce processing consumption and/or memory consumption associated with the model generating the output (e.g., enabling greater scalability and efficiency). In some embodiments, a model constraint may be configured to increase accuracy associated with the output generated by the model. In some embodiments, a model constraint may be in a natural language format.

In some embodiments, a structure constraint may be a data structure that represents one or more functionalities and/or characteristics associated with structure data and/or structure information. A structure constraint may be provided to a model to generate an output. In some embodiments, the model may be a rules-based and/or machine learning model. For example, a structure constraint may be provided to a model such that the output generated by the model may be in a particular structure. In some embodiments, a structure constraint may be configured to increase accuracy associated with the output generated by the model. In some embodiments, a structure constraint may be in a natural language format.

### ADDITIONAL IMPLEMENTATION DETAILS

Although example processing systems have been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. A computer-readable storage medium can be, or be included in, a computer-readable storage device, a computer-readable storage substrate, a random or serial access memory array or device, or a combination of one or more of them. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer needs not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., an LCD monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML (Hypertext Markup Language) page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and at least one non-transitory memory comprising program code, the at least one non-transitory memory and the program code configured to, with the at least one processor, cause the apparatus to at least:
receive, originating from a client computing device, an input data object;
generate, based at least in part by applying a configuration model to the input data object, an intermediate natural language configuration data object;
generate, based at least in part on applying a synthesis model to the intermediate natural language configuration data object, a natural language configuration data object; and
configure the natural language configuration data object for use by a large language model in generating a natural language output representative of the input data object.

2. The apparatus of claim 1, wherein the input data object is in one or more of a recurrent formal structure format or a natural language format.

3. The apparatus of claim 2, wherein the natural language format is one or more of a natural language audio format or a natural language text format.

4. The apparatus of claim 1, wherein generating the natural language configuration data object further comprises the at least one non-transitory memory and the program code being configured to, with the at least one processor, cause the apparatus to at least:
apply the synthesis model to a supplementary intermediate natural language configuration data object.

5. The apparatus of claim 4, wherein the supplementary intermediate natural language configuration data object is representative of one or more of an inclusion constraint, a size constraint, or a structure constraint.

6. The apparatus of claim 1, wherein the configuration model is configured to:
generate, based at least in part on the input data object, an analytic operation instruction, wherein the analytic operation instruction defines at least one analytic operation type; and
determine the intermediate natural language configuration data object based at least in part on the analytic operation instruction.

7. The apparatus of claim 6, wherein the at least one analytic operation type comprises one or more of a filtration operation, a grouping operation, a sorting operation, a trend operation, a correlation operation, an anomaly detection operation, a clustering operation, or a variance operation.

8. A computer-implemented method comprising:
receiving, originating from a client computing device, an input data object;
generating, based at least in part by applying a configuration model to the input data object, an intermediate natural language configuration data object;
generating, based at least in part on applying a synthesis model to the intermediate natural language configuration data object, a natural language configuration data object; and
configuring the natural language configuration data object for use by a large language model in generating a natural language output representative of the input data object.

9. The computer-implemented method of claim 8, wherein the input data object is in one or more of a recurrent formal structure format or a natural language format.

10. The computer-implemented method of claim 9, wherein the natural language format is one or more of a natural language audio format or a natural language text format.

11. The computer-implemented method of claim 8, wherein generating the natural language configuration data object further comprises applying the synthesis model to a supplementary intermediate natural language configuration data object.

12. The computer-implemented method of claim 11, wherein the supplementary intermediate natural language configuration data object is representative of one or more of an inclusion constraint, a size constraint, or a structure constraint.

13. The computer-implemented method of claim 8, wherein the configuration model is configured to:
generate, based at least in part on the input data object, an analytic operation instruction, wherein the analytic operation instruction defines at least one analytic operation type; and
determine the intermediate natural language configuration data object based at least in part on the analytic operation instruction.

14. The computer-implemented method of claim 13, wherein the at least one analytic operation type comprises one or more of a filtration operation, a grouping operation, a sorting operation, a trend operation, a correlation operation, an anomaly detection operation, a clustering operation, or a variance operation.

15. A computer program product comprising at least one non-transitory computer-readable storage medium having computer-readable program code portions stored therein, the computer-readable program code portions comprising an executable portion configured to:
receive, originating from a client computing device, an input data object;
generate, based at least in part by applying a configuration model to the input data object, an intermediate natural language configuration data object;
generate, based at least in part on applying a synthesis model to the intermediate natural language configuration data object, a natural language configuration data object; and
configure the natural language configuration data object for use by a large language model in generating a natural language output representative of the input data object.

16. The computer program product of claim 15, wherein the input data object is in one or more of a recurrent formal structure format or a natural language format.

17. The computer program product of claim 16, wherein the natural language format is one or more of a natural language audio format or a natural language text format.

18. The computer program product of claim 15, wherein generating the natural language configuration data object further comprises the computer-readable program code portions comprise the executable portion configured to:
apply the synthesis model to a supplementary intermediate natural language configuration data object.

19. The computer program product of claim 15, wherein the configuration model is configured to:
generate, based at least in part on the input data object, an analytic operation instruction, wherein the analytic operation instruction defines at least one analytic operation type; and
determine the intermediate natural language configuration data object based at least in part on the analytic operation instruction.

20. The computer program product of claim 19, wherein the at least one analytic operation type comprises one or more of a filtration operation, a grouping operation, a sorting operation, a trend operation, a correlation operation, an anomaly detection operation, a clustering operation, or a variance operation.
